(19) United States
(12) Patent Application Publication
(10) Pub. No.: US 2024/0084620 A1
(43) Pub. Date: Mar. 14, 2024

(54) SAFETY DOOR LOCKING MECHANISM

(71) Applicant: Security Doors and Structures LLC, Canoga Park, CA (US)

(72) Inventor: David Paul Olsen, Calabasas, CA (US)

(21) Appl. No.: 17/931,365

(22) Filed: Sep. 12, 2022

(51) Int. Cl. E05B 59/00; E05B 63/08; E05B 65/10

(52) U.S. Cl. CPC E05B 59/00; E05B 63/08; E05B 65/10

(57) ABSTRACT

Various embodiments are directed to a locking mechanism for a door, the locking mechanism comprising: a central locking component configured to engage one or more locking actuators; a mortise lock linearly coupled to one of the one or more locking actuators of the central locking component, wherein the mortise lock comprises a mortise locking projection configured to be moved between a locked position and an unlocked position; and at least one locking projection, wherein the at least one locking projection is configured to be moved between a locked position and an unlocked position via movement of a respective one of the at least one or more locking actuators, wherein the mortise lock and the at least one locking projection are configured to synchronously move between the respective locked and unlocked positions in response to movement of the central locking component.

### TECHNOLOGICAL FIELD

The present disclosure relates in general to safety doors and more particularly to doors that resist forced entry.

### BACKGROUND

Safety doors are becoming more common for use in different environments including schools and homes. These safety doors are employed to resist forced entries. Applicant has identified a number of deficiencies and problems associated with current safety door locking mechanisms. Through applied effort, ingenuity, and innovation, many of these identified problems have been solved by the methods and apparatuses of the present disclosure.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

Various embodiments described herein relate to safety door locking mechanism. Various embodiments are directed to a locking mechanism for a door, the locking mechanism comprising: a central locking component configured to engage one or more locking actuators; a mortise lock linearly coupled to one of the one or more locking actuators of the central locking component, wherein the mortise lock comprises a mortise locking projection configured to be moved between a locked position and an unlocked position; and at least one locking projection, wherein the at least one locking projection is configured to be moved between a locked position and an unlocked position via movement of a respective one of the at least one or more locking actuators, wherein the mortise lock and the at least one locking projection are configured to synchronously move between the respective locked and unlocked positions in response to movement of the central locking component.

In various embodiments, the mortise lock is configured to be removeable from the central locking component.

In various embodiments, the mortise lock is linearly coupled with the same locking actuator as at least one of the at least one locking projection.

In various embodiments, at least two locking projections are in communication with the same locking actuators.

In various embodiments, at least one of the one or more locking actuators are configured to attach to a bell crank, such that the bell crank is operably coupled to at least one of the at least one locking projection.

In various embodiments, the locking mechanism further comprises a lock activation component configured to move the mortise lock and the locking projections between the locked position and the unlocked position.

In various embodiments, the locking mechanism further comprises a lock engagement mechanism, wherein the lock engagement mechanism is configured to activate the central locking component in response to actuation of the lock engagement mechanism.

In various embodiments, the lock engagement mechanism comprises at least one of a sliding lock or handle.

Various embodiments are directed to a security door comprising: a door frame configured for use within a doorway; at least one door panel attached to the door frame; and a locking mechanism comprising: a central locking component configured to engage one or more locking actuators; a mortise lock linearly coupled to one of the one or more locking actuators of the central locking component, wherein the mortise lock comprises a mortise locking projection configured to be moved between a locked position and an unlocked position; and at least one locking projection, wherein the at least one locking projection is configured to be moved between a locked position and an unlocked position via movement of a respective one of the at least one or more locking actuators, wherein the mortise lock and the at least one locking projection are configured to synchronously move between the respective locked and unlocked positions in response to movement of the central locking component, and wherein the central locking component is attached to one of the at least one door panel and the mortise locking projection and the at least one locking projection are configured to protrude from the door frame in the locked position.

In various embodiments, the door frame comprises a top door frame component, a bottom door frame component, a hinge side door frame component, and an opening side door frame component, wherein, in the locked position, at least one of the mortise locking projection or the at least one locking projection is configured to protrude from at least two of the top door frame component, the bottom door frame component, the hinge side door frame component, or the opening side door frame component.

In various embodiments, the mortise locking projection and the at least one locking projection are configured to be perpendicular to the door frame.

In various embodiments, the door frame comprises a first door panel configured to be attached to the door frame on a first side and a second door panel configured to be attached to the door frame on a second side, wherein the second side is disposed opposite the first side.

In various embodiments, each of the locking projections is disposed within the security door in the locked position.

In various embodiments, the door frame is configured to be received by a doorway comprising one or more receiving components, wherein at least one of the mortise locking projection or the at least one locking projection is configured to be received by a respective one of the one or more receiving components.

In various embodiments, the mortise lock is configured to be removeable from the central locking component.

In various embodiments, the mortise lock is linearly coupled with the same locking actuator as at least one of the at least one locking projection.

In various embodiments, at least two locking projections are in communication with the same locking actuators.

In various embodiments, the security door further comprises a lock activation component configured to move the mortise lock and the locking projections between the locked position and the unlocked position.

In various embodiments, the security door further comprises a lock engagement mechanism, wherein the lock engagement mechanism is configured to activate the central locking component in response to actuation of the lock engagement mechanism.

In various embodiments, the lock engagement mechanism comprises at least one of a sliding lock or handle.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described the disclosure in general terms, reference will now be made to the accompanying drawings, which are not necessarily drawn to scale, and wherein:

FIG. 1A illustrates an example safety door with a locking mechanism of an example embodiment of the present disclosure;

FIG. 1B is an additional two-dimensional view of a locking mechanism of an example embodiment installed on a door frame of the present disclosure;

FIG. 2A illustrates a close-up view of a central locking component of a locking mechanism of an example embodiment of the present disclosure;

FIG. 2B illustrates a close-up view of the central locking component interaction with a mortise lock in accordance with an example embodiment of the present disclosure;

FIGS. 2C and 2D illustrate an example coupling mechanism of the central locking component in accordance with an example embodiment of the present disclosure;

FIG. 2E illustrates a close-up view of the coupling mechanism interaction with the mortise lock in accordance with an example embodiment of the present disclosure;

FIG. 2F illustrates a cross section of an example safety door with a locking mechanism of an example embodiment of the present disclosure;

FIG. 3A illustrates an opening side door frame component of the safety door of an example embodiment with the locking mechanism actuated;

FIG. 3B illustrates a top door frame component of the safety door of an example embodiment with the locking mechanism actuated;

FIG. 3C illustrates a hinge side frame component of the safety door of an example embodiment with the locking mechanism actuated;

FIG. 3D illustrates a cutaway view of a safety door of an example embodiment with the locking mechanism actuated;

FIGS. 4A and 4B illustrate example bell cranks used in example embodiments of the present disclosure;

FIG. 5A is an example doorway for use with an example safety door of the present disclosure;

FIG. 5B illustrates an example safety door showing example locking projection apertures; and

FIGS. 6A and 6B illustrate an example jamb assembly used in example embodiments of the present disclosure.

### DETAILED DESCRIPTION

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, terms such as “front,” “rear,” “top,” etc. are used for explanatory purposes in the examples provided below to describe the relative position of certain components or portions of components. For example, the term “top edge” may be used to describe an edge of a component; however, the edge may be on the top, bottom, or side, depending on the orientation of the particular component being described. As used herein, the terms ‘substantially’ and ‘approximately’ refer to tolerances within manufacturing and/or engineering standards.”

Safety doors are sometimes installed in place of traditional doors in schools, homes, and the like, to allow for increased safety of building occupants from intruders. The safety doors discussed herein may have the same dimensions as a traditional door and can be installed in a standard doorway with minimal changes to an existing doorframe (e.g., only drilling of holes into the doorway for accommodating the locking projections may be needed). Additionally, the safety door of various embodiments may also operate as a traditional door during non-emergency conditions. For example, a safety door may be opened and closed without activating the locking mechanism. Therefore, the safety doors of various embodiments can be used in everyday situations, but can also provide upgraded security during emergency conditions.

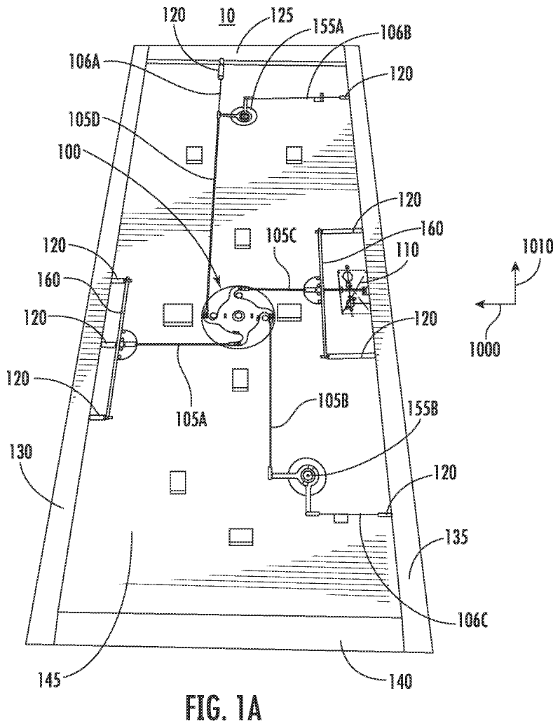

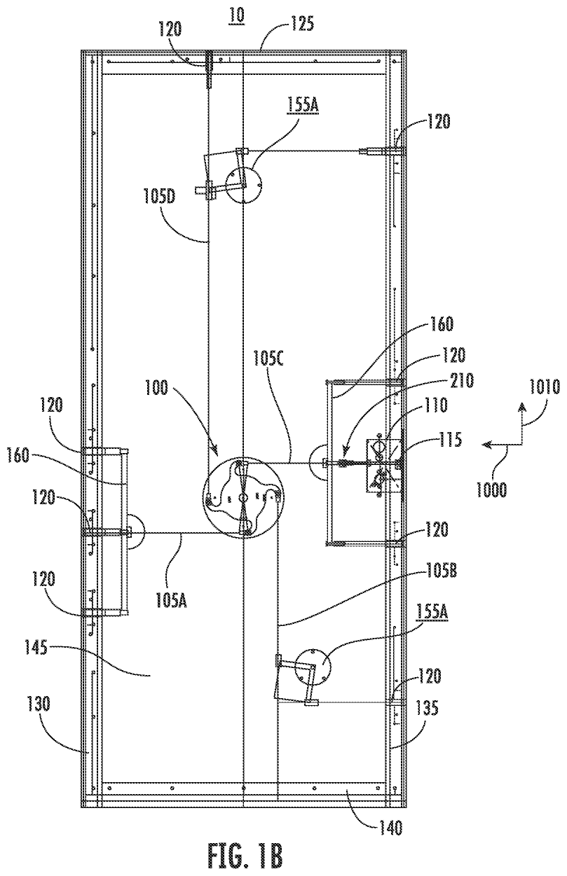

With reference to FIGS. 1A and 1B, a safety door 10 with a locking mechanism of various embodiments is shown installed in a door panel. In various embodiments, as shown, the safety door 10 may include a top door frame component 125, a hinge door frame component 130, an opening side door frame component 135, and a bottom door frame component 140. In various embodiments, the top door frame component 125, the hinge door frame component 130, the opening side door frame component 135, and the bottom door frame component 140 may be attached to form a frame (e.g., a rectangular shape).

In various embodiments, a first end of the top door frame component 125 may be attached to a first end of the hinge door frame component 130. In various embodiments, the attachment of the top door frame component 125 to the hinge door frame component 130 may form approximately a right angle (e.g., 90 degrees). In various embodiments, a second end of the top door frame component 125 may be attached to a first end of the opening side door frame component 135. In various embodiments, the attachment of the top door frame component 125 to the hinge door frame component 130 may form approximately a right angle (e.g., 90 degrees). In various embodiments, a first end of the bottom door frame component 140 may be attached to a second end of the hinge door frame component 130. In various embodiment, the attachment of the bottom door frame component 140 and the hinge door frame component 130 may form approximately a right angle (e.g., 90 degrees). In various embodiments, a second end of the bottom door frame component 140 may be attached to a second end of the opening side door frame component 135. In various embodiment, the attachment of the bottom door frame component 140 and the hinge door frame component 135 may form approximately a right angle (e.g., 90 degrees). In various embodiments, the frame components 125, 130, 135, 140 may be attached via glue, screws, nails, and/or the like.

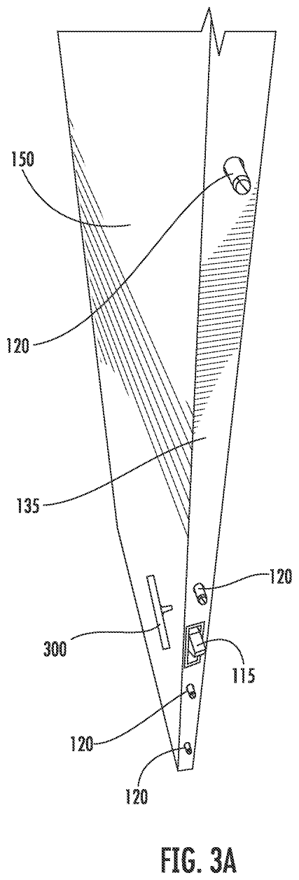

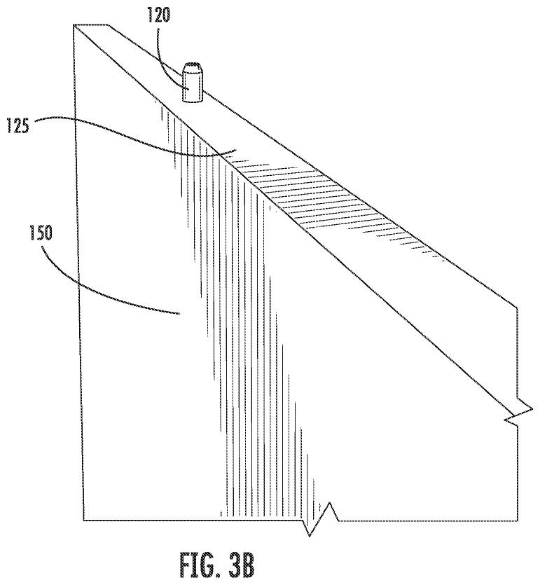

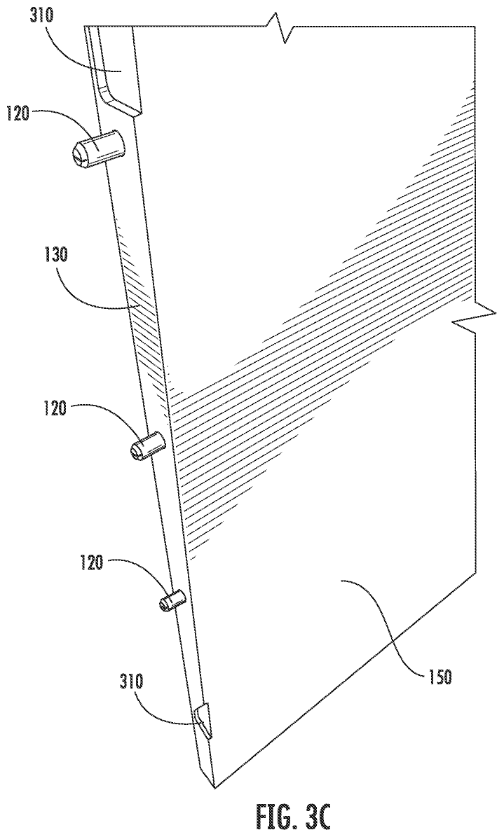

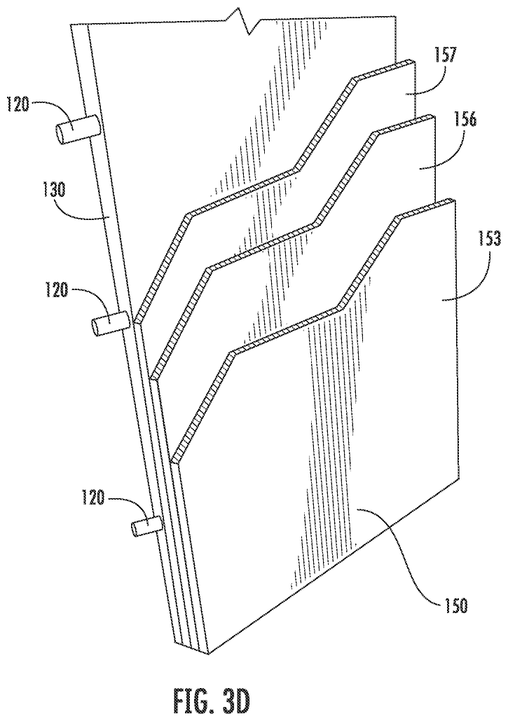

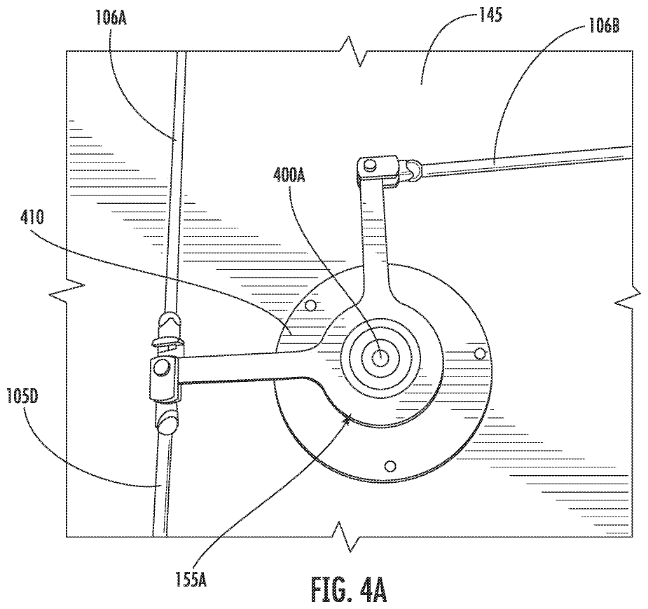

In various embodiments, the safety door 10 may also include a first door panel 145 and a second door panel 150 (shown in FIGS. 3A-3D, removed from FIGS. 1A-1B to allow for a better view of the locking mechanism). In various embodiments, the first door panel 145 may be attached to one side of the door frame. In various embodiments, the second door panel 150 may be attached to the side of the door frame opposite the side to which the first door panel 145 is attached. As such, in various embodiments, the safety door 10 may be hollow between the door panels 145, 150 (e.g., to allow for the locking mechanism to be disposed therein). In various embodiments, the door panels 145, 150 may be attached to the door frame via glue, screws, nails, and/or the like. In various embodiments, the door panels 145, 150 may be one or more layers 151. For example, in some embodiments, each of the door panels 145, 150 may include one or more ballistic panels 156 and/or one or more Kevlar panels 157, that may function at least in part to strengthen the door panels 145, 150 such that the damage resistance may be increased. In various embodiments, each of the door panels 145, 150 may additionally include a door skin 153, and/or a door façade (not shown) to provide a desired aesthetic to the door. For example, various wood materials (e.g., hardwoods or softwoods) may be provided in one or more layers on the outer surface of the door to provide a desired aesthetic. These wood materials may be provided as a planar door skin and/or as a multi-layer door skin (e.g., providing an aesthetic of a raised-panel door skin). Other aesthetics may be provided as desired by a user.

In various embodiments, a locking mechanism may be disposed within the safety door 10. The locking mechanism may include a central locking component 100 (e.g., central locking mechanism), one or more locking actuators 105, a mortise lock 110, and one or more locking projections 120.

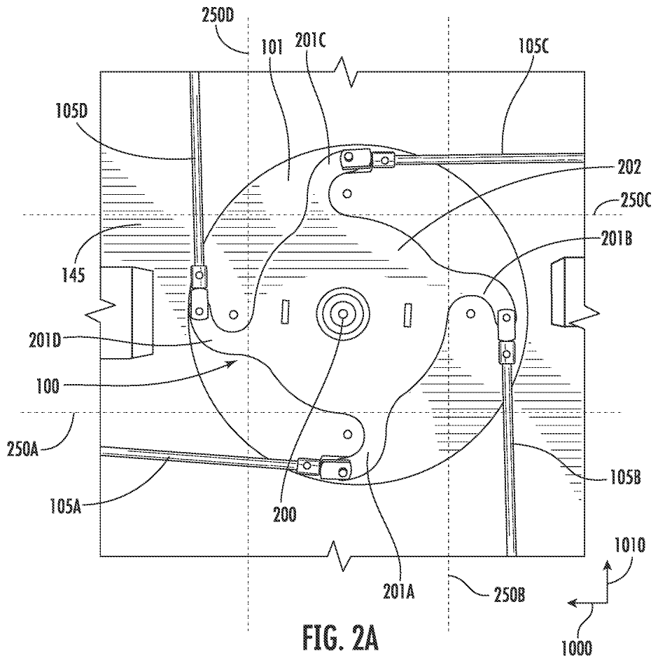

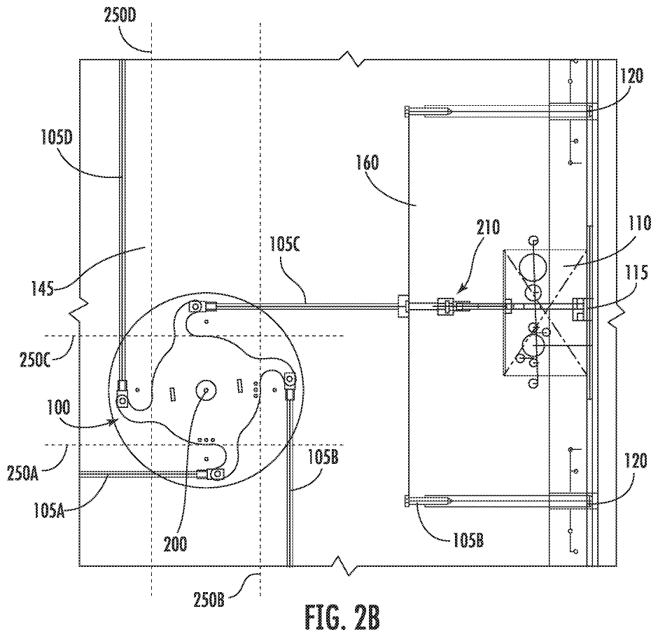

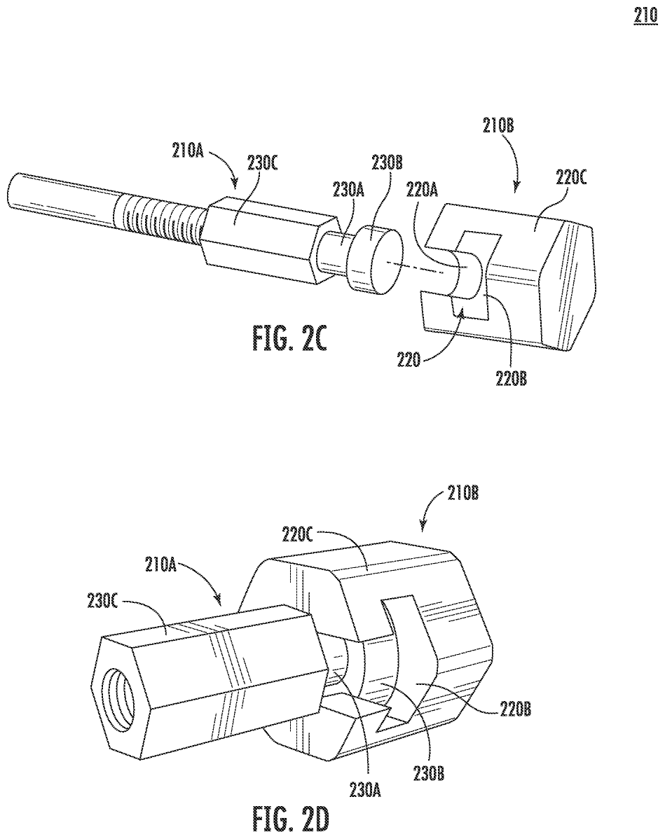

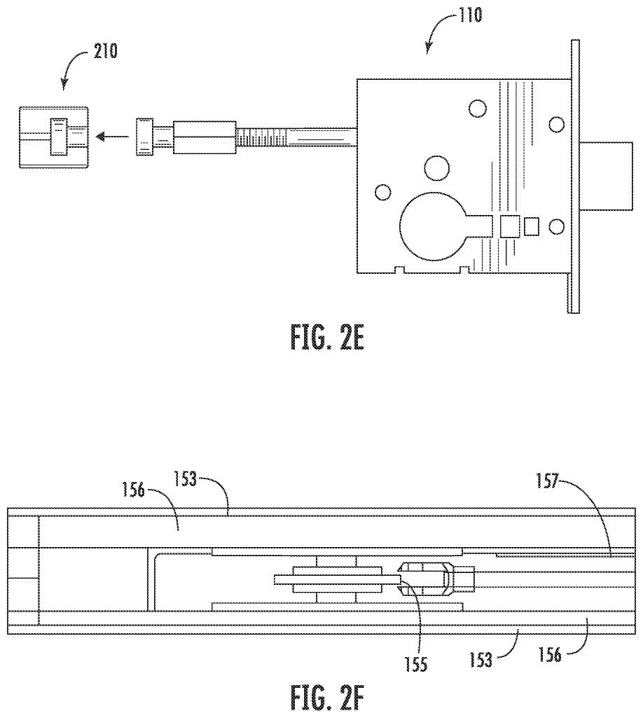

In various embodiments, the central locking component 100 may be rotatably attached to a first door panel 145 of the safety door 10. Upon actuation, the central locking component 100 may rotate (e.g., about a center of rotation 200 shown in FIG. 2A). As the central locking component 100 rotates, the locking projections 120 and mortise locking projection 115 may move synchronously in response to said rotation. For example, as the central locking component 100 rotates, the locking actuators 105A-105D are moved in response, such that the locking projections 120 and mortise locking projection 115 are also moved in response.

In various embodiments, the central locking component 100 may have a generally circular main body 202 with a plurality of fingers 201A-201D extending from the main body 202. In various embodiments, a locking actuator 105A-105D may be attached to the central locking component 100 via a respective one of said fingers 201A-201D. As such, the locking actuators 105A-105C, may be oriented substantially parallel to a line drawn tangent to the circular main body 202. For example, as shown in FIG. 2B, the first locking actuator 105A may be substantially parallel to the tangent line 250A, the second locking actuator 105B may be substantially parallel to the tangent line 250B, the third locking actuator 105C may be substantially parallel with the tangent line 250C, and the fourth locking actuator 105D may be substantially parallel with the tangent line 250D. As such, the rotation of the central locking component 100 may cause the locking mechanism 105A-105D to move along a first axis 1000 or second axis 1010 (e.g., substantially parallel with the given tangent line 250A-250D). For example, the first locking actuator 105A and third locking actuator 105C may move along the first axis 1000 (e.g., the first axis 1000 may be substantially parallel with the top door frame component 125 and the bottom door frame component 140) and the second locking actuator 105B and the fourth locking actuator 105D may move along the second axis 1010 (e.g., the second axis 1010 may be substantially parallel with the hinge door frame component 130 and the opening side door frame component 135).

In various embodiments, the one or more locking actuators 105 may be attached to the central locking component 100, such that as the central locking component 100 is actuated (e.g., rotated), the locking actuators 105 may move accordingly. While four locking actuators 105A-105D are shown in FIGS. 1A-1B, various embodiments may have more or fewer locking actuators. In various embodiments, each locking actuator 105A-105D may be in communication with at least one of at least one of the locking projections 120 or the mortise lock 110, such that the movement of the given locking actuator 105A-105D may also cause the corresponding locking projection(s) 120 and/or mortise locking projection 115 to move between the locked position and the unlocked position.

In various embodiments, the given locking actuator 105A-105D may be in communication with at least one of the locking projections 120 or the mortise lock 110 via an actuator connector 160, a linear coupling mechanism 210, a locking actuator extender 106, a bell crank 155, and/or the like. In various embodiments, a locking actuator 105A-105D may be attached directly to a locking projection 120.

In various embodiments, an actuator connector 160 may be attached to a locking actuator (e.g., with reference to FIGS. 1A and 1B, an actuator connector 160 is attached to the first locking actuator 105A, and another actuator connector 160 is attached to the third locking actuator 105C). The actuator connector 160 may allow for a plurality of locking projections 120 to be in communication with a common locking actuator 105A, 105C. For example, two locking projections 120 are attached to the actuator connector 160 attached to the third locking actuator 105C, and three locking projections 120 are attached to the actuator connector 160 attached to the first locking actuator 105A. As such, when the third locking actuator 105C is moved, the corresponding two locking projections 120 are moved in response via the respective actuator connector 160. Likewise, when the first locking actuator 105A is moved, the corresponding three locking projections 120 are moved in response via the respective actuator connector 160.

In various embodiments, additional locking projections 120 may be provided along the actuator connector 160. The actuator connector 160 may be substantially perpendicular to the attached locking actuator 105A, 105C. In various embodiments, the actuator connector 160 may be substantially parallel to the door frame component with which the attached locking projections 120 engage. Additionally, the actuator connector 160 may be substantially perpendicular to the attached locking projections 120, such that the locking projections 120 may be substantially perpendicular to the door frame (e.g., the locking projections 120 in communication with the first locking actuator 105A may be substantially perpendicular to the hinge door frame component 130 and the locking projections 120 in communication with the third locking actuator 105C may be substantially perpendicular to the opening side door frame component 135).

In various embodiments and discussed in more detail below with reference to FIG. 2B, one of the locking actuators 105C may be in communication with a mortise lock 110 via a linear coupling mechanism 210. As such, as the central locking component 100 rotates, the mortise locking projection 115 of the mortise lock 110 may be moved between a locked position and an unlocked position. In various embodiments, the movement of the mortise locking projection 115 may be synchronous with the movement of the locking projections 120. In various embodiments, the locking actuator in communication with the mortise lock 110 (e.g., the third locking actuator 105C) may also be in communication with one or more locking projections 120 (e.g., via the actuator connector 160 attached to the third locking actuator 105C). As discussed in more detail with reference to FIG. 2A, in various embodiments, the linear coupling mechanism 210 may be configured to allow for the mortise lock 110 to be detached from the locking mechanism (e.g., for maintenance).

In various embodiments, the linear coupling mechanism 210 may be provided along one of the locking actuators (e.g., the third locking actuator 105C), such that the third locking actuator 105C may be split into two pieces that may be coupled and/or decoupled via the linear coupling mechanism 210 (e.g., the linear coupling mechanism 210 may be disposed between the mortise lock 110 and the central locking component 100). With reference to FIG. 2C, the linear coupling mechanism 210 may include a male coupler 210A and a female coupling receiver 210B, such that the male coupler 210A may be attached to one of the pieces of the locking actuator and the female coupler receiver 210B may be attached to the other piece of the locking actuator. Additionally, the male coupler 210A and the female coupling receiver 210B may be releasably attached to one another. Still with reference to FIG. 2C, in various embodiments, the male coupler 210A may have a body 230C, a neck 230A that is secured to the body 230C, and a head 230B that is attached to the neck 230A. In various embodiments, the neck 230A and the head 230B may be substantially circular (e.g., round). In various embodiments, the female coupler receiver 210B may have a body 220C defining a slot 220 (e.g., opening) for receiving the neck 230A and the head 230B of the male coupler 210A. For example, the male coupler 210A and the female coupling receiver 210B may be releasably attached by sliding the neck 230A and the head 230B into the slot 220.

In various embodiments, the slot 220 defined by the body 220C of the female coupler receiver 210B may include a hollow neck portion 220A for receiving the neck 230A of the male coupler 210A and a hollow head portion 220B for receiving the head 230B of the male coupler 210A. In various embodiments, the neck portion 220A may define a first arc and the head portion 220B may define a second arc, where the head portion 220B may have a radius curvature that is larger than the radius of curvature of the neck portion 220A and/or the head portion 220B may have a diameter that is larger than the diameter of the neck portion 220A, such that the head portion 220B defines a recess for receiving at least a portion of the head 230B of the male coupler 210A therein. Accordingly, the male coupler 210A and the female coupling receiver 210B may be releasably attached by sliding the neck 230A and the head 230B respectively into the neck portion 220A and the head portion 220B of the slot 220. In this manner, when a linear force is applied via other components of the locking mechanism, the components of the linear coupling mechanism 210 remain securely attached. However, the male coupler 210A and the female coupler receiver 210B may be detached from one another (e.g., by sliding the components in a direction perpendicular to the typical linear force such that the neck 230A and the head 230B may be removed from the slot 220). In some embodiments, the slot 220 may have a substantially “T” shape, where the neck portion 220A corresponds to the vertical portion of the “T” shape, and the head portion 220B corresponds to the horizontal portion of the “T” shape.

As such, in a configuration in which the male coupler and the female coupling receiver are coupled, the third locking actuator 105C moves the mortise locking projection 115 between the locked position and the unlocked position. However, the linear coupling mechanism 210 also allows for the disengagement of the linear coupling mechanism from the mortise lock, such that the mortise lock 110 may be removed from the locking mechanism (e.g., for maintenance or replacement). For example, the linear coupling mechanism 210 may be disengaged by moving the ridge of the male coupler out of the slot of the female coupling receiver, thereby allowing for separation the two components of the linear coupling mechanism 210. In such a configuration in which the male coupler and the female coupling receiver are disengaged, the mortise locking projection 115 is in turn also disengaged from the third locking actuator 105C.

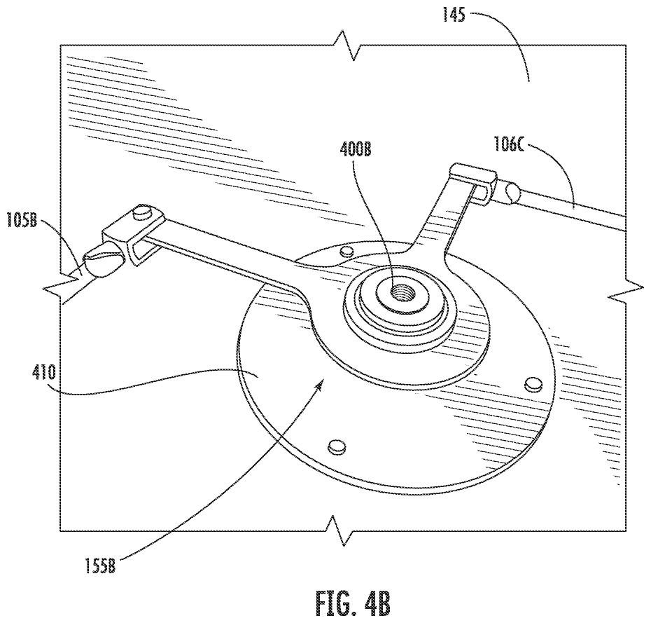

In various embodiments, as shown in more detail in FIGS. 4A and 4B, the locking mechanism may include a bell crank 155A, 155B attached to a locking actuator 105. The bell cranks 155A, 155B may be provided to transfer the movement of one of the locking actuators from the first axis 1000 to the second axis 1010 (shown in FIG. 1A) or vice versa. In various embodiments, the bell crank 155A, 155B may be rotatably attached to the first door panel 145 (e.g., the first bell crank 155A may be attached at center of rotation 400A and the second bell crank 155B may be attached at center of rotation 400B). As shown, in some embodiments, a plate 410 may be rigidly attached to the first door panel 145, and the given bell crank 155A, 155B may be rotatably attached to said plate 410 (e.g., the bell crank may be attached to the door panel via the plate, rather than directly attached).

Referring to FIG. 4A, in various embodiments, the first bell crank 155A may be in communication with the fourth locking actuator 105D, which moves along the second axis 1010 (e.g., substantially parallel to the hinge door frame component 130 and the opening side door frame component 135) and transfers the movement of the fourth locking actuator to a locking projection 120 moving along the first axis 1000 (e.g., substantially perpendicular to the opening side door frame component 135). In various embodiments, as shown with respect to the fourth locking actuator 105D, the locking actuator may be in communication with two locking projections, each of which protrudes from a different frame component of the door frame. For example, as seen in FIG. 1A, the fourth locking actuator 105D may be in communication with a locking projection 120 that protrudes from the top door frame component 125 and a locking projection 120 that protrudes from the opening side door frame component 135.

Referring to FIG. 4B, in various embodiments, the second bell crank 155B may be in communication with the second locking actuator 105B, which moves along the second axis 1010 (e.g., substantially parallel to the hinge door frame component 130 and the opening side door frame component 135) and transfers the movement to a locking projection 120 moving along the first axis 1000 (e.g., substantially perpendicular to the opening side door frame component 135).

In various embodiments, each locking projection 120 may thus be attached directly or indirectly to a locking actuator 105A-105D. For example, the given locking actuator 105A-105D may, in some cases, be attached to a respective one or more locking projections 120 via an actuator connector 160, a linear coupling mechanism 210, a locking actuator extender 106, a bell crank 155, and/or other components, as described above, in order to achieve the desired motion and engagement of the locking projections 120 with the receiving mechanism 510 in an instance in which the door 10 is installed on a doorway 500. In various embodiments, the locking projections 120 may have a diameter of at least 6 mm. In preferred embodiments, the locking projection may have a diameter of at least 12 mm. However, other diameters may be utilized, as appropriate for a particular application. The locking projections may be made from steel, titanium, brass, aluminum, zinc alloy, or other generally rigid materials.

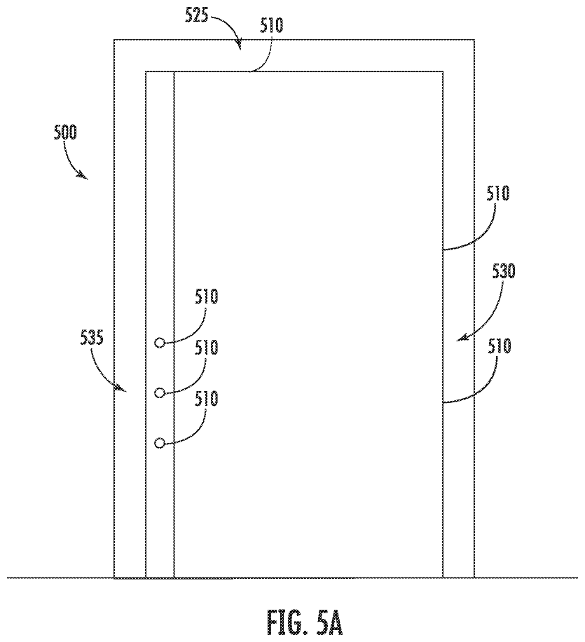

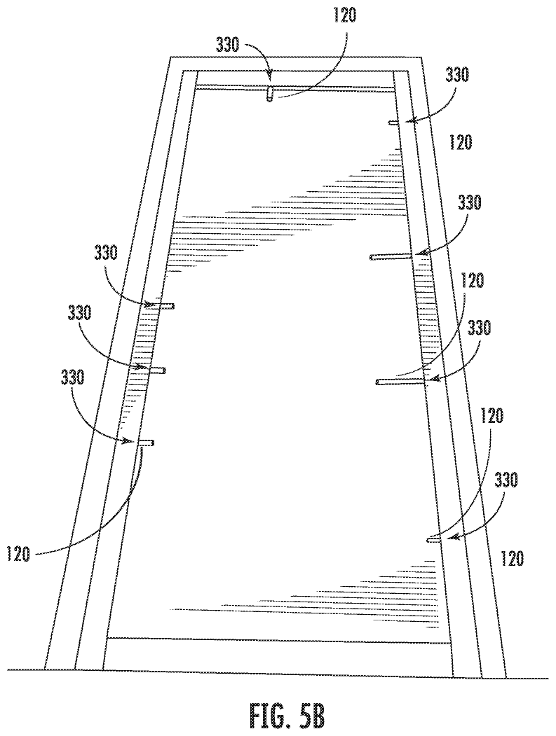

In various embodiments, the locking projections 120 are each configured to travel through an aperture in the door frame to engage the receiving mechanism 510, shown in FIG. 5A. In various embodiments, as shown in FIG. 5B, the door frame may have one or more locking projection apertures (e.g., along one or more of the top door frame components 125, the hinge door frame component 130, the opening side door frame component 135, or the bottom door frame component 140). In various embodiments, the one or more locking projection apertures 330 may be aligned with the locking projection 120, such that the locking projection passing therethrough is oriented substantially perpendicularly to the door frame. In various embodiments, the locking projections 120 may be configured to travel between a locked position and an unlocked position. The locking projections 120 may travel along the first axis 1000 or the second axis 1010 such that each locking projection is moving in a direction substantially perpendicular to the respective door frame component. In various embodiments, the unlocked position may be defined as a configuration in which the distal end of the locking projection 120 is within the safety door 10 (i.e., not extending beyond the exterior surface of the door frame), such that the door 10 may be opened. Similarly, the locked position may be defined as a configuration in which the distal end of the locking projection 120 is protruding from the edge of the door and into the door frame, such that it engages one of the receiving mechanisms 510 and prevents the safety door 10 from being opened.

In various embodiments, each of the locking projections 120 may move synchronously between the locked position and the unlocked position, such that all projections are in the unlocked position or all projections are in the locked position simultaneously. In various embodiments, as discussed in more detail below, the mortise locking projection 115 of the mortise lock 110 may also move synchronously with the locking projections 120.

Referring now to FIG. 2A, a closer view of the central locking component 100 is shown installed on the first door panel 145. In various embodiments, the central locking component 100 may be rotatably attached to the first door panel 145 at a center of rotation 200. In various embodiments, as shown in FIG. 2A, the central locking component 100 may be rotatably attached to a plate 101, which in turn is fixedly attached to the first door panel 145 (e.g., the plate 101 may be fixedly attached to the first door panel 145 and the central locking component 100 may be rotatably attached to the plate 101 instead of to the first door panel 145 directly).

Referring now to FIG. 2B, the interaction between the central locking component and the mortise lock in accordance with an example embodiment is described. In various embodiments, one of the locking actuators (e.g., third locking actuator 105C as depicted in the figure) may be removably coupled to the mortise lock 110 via the linear coupling mechanism 210 discussed above.

In various embodiments, the locking actuator in communication with the mortise lock 110 may also be in communication with one or more locking projections 120. As shown, the third locking actuator 105C may be connected to a actuator connector 160, which is connected to one or more locking projections 120. In various embodiments, the locking projections 120 may move synchronously with the mortise locking projection 115 and the locking projections 120 in communication with other locking actuators.

Referring now to FIGS. 3A-3C, the locking projections 120 and mortise lock 110 are shown in the locked position along the opening side door frame component 135 (FIG. 3A), the top door frame component 120 (FIG. 3B), and the hinge door frame component 130 (FIG. 3C). As shown, in various embodiments, the locking projections 120 and mortise locking projection 115 may protrude from the door frame in the locked position (e.g., the protruded locking projections 120 and mortise locking projection 115 may be at least partially received by doorway 500, such as via the receiving components 510 provided in the doorway as shown in FIG. 5A).

As shown in FIG. 3A, the safety door may have a lock actuation mechanism (e.g., handle 300) configured to activate the central locking component 100 and subsequently move the locking projections 120 and the mortise locking projection 115 synchronously between the unlocked position and the locked position. In various embodiments, the safety door 10 may also have a secondary lock actuation mechanism (not shown) configured to operate just the mortise lock 110 (e.g., during non-emergency situations, in which the locking projections do not need to be activated). In various embodiments, the secondary lock actuation mechanism may be a knob, a lever, or other types of door handle. For example, in some embodiments, the secondary lock actuation mechanism may be a deadbolt knob configured to deactivate the locking projections by turning the deadbolt knob in a defined direction and activating the locking projections by turning the deadbolt knob in the opposite direction.

In various embodiments, both the first door panel 145 and the second door panel 150 may have a similar design, such that each may be configured to resist damage (e.g., either side of the door may be used as a defensive side and either door panel 145, 150 may be used as an exterior panel). In various embodiments, the door panels 145, 150 may be designed to withstand a particular amount or type of damage. For example, some panels may be configured to withstand gun shots from a 9-millimeter ammunition gun, while others may be designed to withstand higher caliber ammunition. Certain panels may comprise wood, fiberglass, Kevlar, composite materials, and/or other materials to provide a desired strength and/or aesthetic. Various materials may be used to strengthen the door panel 145, 150. For example, each of the door panels 145, 150 may include one or more ballistic panels 156 and/or one or more Kevlar panels 157. Additionally or alternatively, a plurality of layers may be employed for the door panel 145, 150, such that the damage resistance may be increased. In various embodiments, each of the door panels 145, 150 additionally includes a door skin, and/or a door façade to provide a desired aesthetic to the door. For example, various wood materials (e.g., hardwoods or softwoods) may be provided in one or more layers on the outer surface of the door to provide a desired aesthetic. These wood materials may be provided as a planar door skin and/or as a multi-layer door skin (e.g., providing an aesthetic of a raised-panel door skin). Other materials may be utilized to provide alternative aesthetics as desired by a user.

As shown in FIG. 2F, in some embodiments, each door panel 145, 150 may include a door skin 153 secured relative to a ballistic panel 156. In some embodiments, the door skins 153 and the ballistic panels may extend the width of the door panel 145, 150. In various embodiments, each door skin 153 may have a thickness of about 0.125 inches or other suitable thickness (e.g., based at least in part on the application), and the ballistic panels 156 may have a thickness of about 0.5 inches, a thickness of about 0.3125 inches, a thickness of about 0.25 inches, or other suitable thickness based at least in part on the application. In some embodiments, the thickness of the ballistic panels 156 for door panels 145, 150 may be the same. In some embodiments, the thickness of the ballistic panel 155 for door panel 145 may be different from the thickness of the ballistic panel 156 for door panel 150. In some embodiments, door panel 145 and/or door panel 150 may include one or more Kevlar panels 157 secured relative to the corresponding ballistic panel 156. As shown in FIG. 2F, in some embodiments, the one or more Kevlar panels 157 may be secured to the side of the ballistic panel proximate to the locking mechanism, while the door skin 153 may be secured to the opposite side of the ballistic panel 156. In some embodiments, the one or more Kevlar panels 157 may extend only a portion of the width of the door panel.

As shown in each of FIGS. 3A-3C, in the locked position, the locking projections 120 protrude from the door frame, such that in an instance in which the door is closed, the locking projections 120 may engage with the receiving components 510 of the doorway 500 as shown in FIG. 5A. Additionally, in some embodiments, one or more locking projections may protrude from the bottom door frame component 140 and to be received by a corresponding receiving component defined in the floor (e.g., a hole in the floor may be drilled to receive a locking projection). In various embodiments, the locking projections 120 may extend beyond the frame when in the locked position. In various embodiments, the locking projections 120 are configured to extend at least 12 mm beyond the frame when in the locked position. In one embodiment, the locking projections 120 are configured to extend at least 25 mm beyond the frame when in the locked position. In another preferred embodiment the locking projections 120 are configured to extend at least 63 mm outside the frame.

Additionally, as shown in FIG. 3A, the mortise locking projection 115 is also configured to protrude from the door frame (e.g., from the opening side door frame component 135) when in a locked position. In various embodiments, the receiving component 510 that receives the mortise locking projection 115 may be specially designed to receive the mortise locking projection 115.

Referring now to FIG. 5A, an example doorway 500 is provided in accordance with example embodiments that is configured to have safety door installed therein. The receiving components 510 may be positioned and configured (e.g., sized and shaped) to receive the locking projections 120 protruding from the hinge door frame component 130. As depicted in FIG. 5A, receiving components 510 may be provided around the doorway and, in some cases in the floor, to receive locking projections 120 or the mortise locking projection 115 discussed herein, as will be understood by one skilled in the art in light of this disclosure.

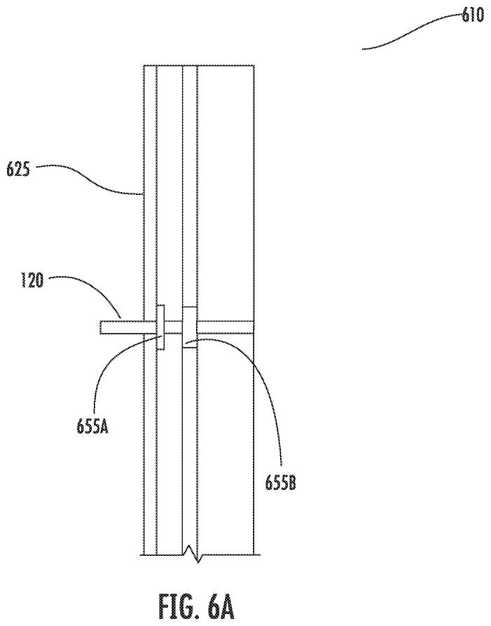

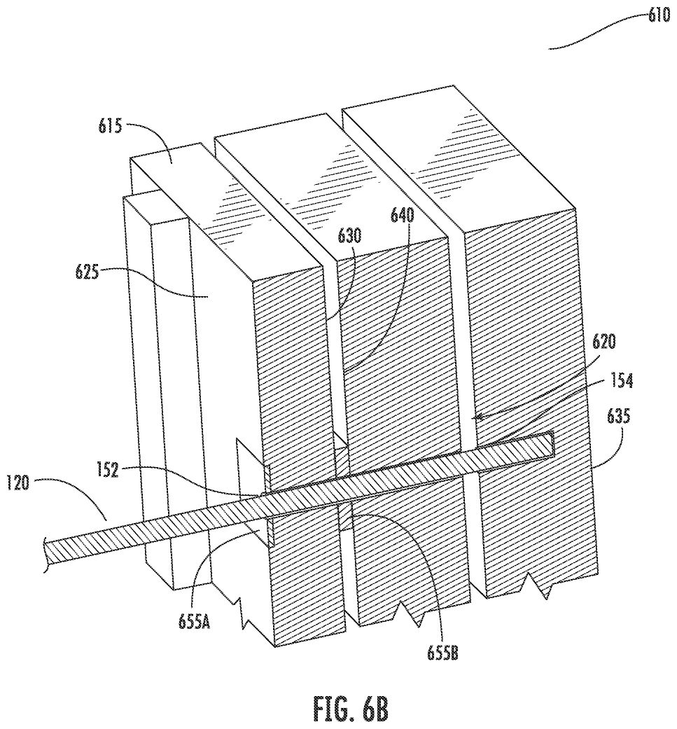

In various embodiments, the doorway 500 may be a standard sized doorway with receiving components 510 added therein. As discussed in reference to FIGS. 6A-6B, the doorway 500 may have added structure (e.g., additional framing) added within the wall, adjacent the doorway 500, such that the locking projections 120 may extend into this added structure when in the locked position. For example, in some cases, each receiving component 510 may comprise a notch or cavity defined by the added structure and configured (e.g., sized and shaped) to receive a locking projection 120 or mortise locking projection 115. In various embodiments, the receiving components 510 may be defined substantially perpendicular to the doorway (e.g., to receive the substantially perpendicular locking projections or mortise locking projection). The location of the receiving components 510 may be based on the position of the locking projections 120 and mortise locking projection 115 on the door frame, such that each receiving component 510 may align with a corresponding locking projection 120 or mortise locking projection 115. As discussed herein, the receiving components 510 may comprise one or more strike-plates to further increase the structural strength of the receiving components 510.

In various embodiments, as shown in FIG. 5A, the doorway may include a top doorway frame component 525, a hinge doorway frame component 530, and an opening side doorway frame component 535. In various embodiments, the top doorway frame component 525, the hinge doorway frame component 530, and the opening side doorway frame component 535 may be attached to form a doorway frame. In various embodiments, a first end of the top doorway frame component 525 may be attached to a first end of the hinge doorway frame component 530. In various embodiments, the attachment of the top doorway frame component 525 to the hinge doorway frame component 530 may form approximately a right angle (e.g., 90 degrees). In various embodiments, a second end of the top doorway frame component 525 may be attached to a first end of the opening side doorway frame component 535. In various embodiments, the attachment of the top doorway frame component 525 to the opening side doorway frame component 535 may form approximately a right angle (e.g., 90 degrees). In various embodiments, the frame components 525, 530, 535 may be attached via glue, screws, nails, and/or the like.

In various embodiments, each doorway frame component 525, 530, 535 includes a jamb assembly or is otherwise defined by a jamb assembly. In various embodiments, the receiving components 510 for each doorway frame components 525, 530, 535 are disposed on the corresponding jamb assembly for the respective doorway frame component 525, 530, 535. In various embodiments, the jamb assembly for each doorway frame component 525, 530, 535 may have substantially the same structure. With reference to FIG. 6A, which depicts a side view of a portion of an example jamb assembly 610 and FIG. 6B, which depicts a cutaway of the example jamb assembly 610 (specifically focusing on the receiving portion 510 through which the locking projection extends) for the doorway frame components 525, 530, 535, the jamb assembly 610 may extend the length of the corresponding doorway frame component 525, 530, 535. In various embodiments, the jamb assembly may be made from wood, wood substrate, steel, and/or the like. It should be noted that the configuration reflected in FIGS. 6A-6B may be provided at each receiving portion 510 around the perimeter of the doorway.

In various embodiments, the jamb assembly 610 may include one or more jamb portions. In various embodiments, the jamb assembly 610 may include a first jamb portion 615 (the portion that is visible as the door frame) and a second jamb portion 620 (located within an interior to a wall surrounding the door). In various embodiments, the first jamb portion 615 may include a door-facing surface 625 and a first inner-facing surface 630. In various embodiments, the second jamb portion 620 may include an outer-facing surface 635 and a second inner-facing surface 640. In various embodiments, the first jamb portion 615 defines one or more locking projection openings 152 that each extend the entire length of the first jamb portion 615 (from the door-facing surface 625 through to the first inner-facing surface 630), and the second jamb portion 620 defines one or more locking projection cavities 154 that each extend a portion of the length of the second jamb portion 620 (from the second inner-facing surface 640 therethrough). For each door jamb assembly, the location of the one or more locking projection openings 152 defined by the first jamb portion 615 and the one or more locking projection cavities 154 defined by the second jamb portion 620 may be based on the position of the locking projections 120 on the door frame facing the respective jamb assembly (i.e., the door frame adjacent to the respective jamb assembly), such that each locking projection opening 152 and each locking projection cavity 154 may align with a corresponding locking projection 120.

In various embodiments, the first jamb portion 615 and the second jamb portion 620 may be attached to each other such that the first inner-facing surface 630 of the first jamb portion 615 and the second inner-facing surface 640 of the second jamb portion 620 are substantially adjacent to each other. In various embodiments, the first jamb portion 615 and the second jamb portion 620 may be attached to each other using fastening mechanisms such as nails, glue, screws, and/or the like. One or more spacers may be positioned between the first jamb portion 615 and the second jamb portion 620 to accommodate a strike plate 655B therebetween. In various embodiments, the first jamb portion 615 and the second jamb portion 620 may be made from the same material (e.g., wood, wood substrate, steel, and/or the like). In various embodiments, the first jamb portion 615 and the second jamb portion 620 may be made from different materials (e.g., wood, wood substrate, steel, and/or the like).

In various embodiments, the jamb assembly 610 may include one or more sets of strike plates each defining an opening configured for receiving a locking projection 120 therethrough. In various embodiments, for each doorway frame component 525, 530, 535, the corresponding jamb assembly 610 may include a set of strike plates for each receiving component 510 of the doorway frame component. In various embodiments, each set of strike plates may include a first strike plate 655A and a second strike plate 655B. The first and second strike plates 655A, 655B may be made from steel, titanium, brass, aluminum, zinc alloy, and/or other suitable materials. In various embodiments, the first strike plate 655A of a set of strike plates may be mounted and positioned on (e.g., embedded to be flush with) the door-facing surface 625 of the first jamb portion 615 such that the opening defined by the first strike plate 655A aligns with the corresponding receiving component 510 (e.g., the corresponding locking projection opening 152 and cavity 154 of the jamb assembly 610) so as to allow a locking projection 120, when activated, to pass through the first strike plate 655A and into the corresponding receiving component 510. In various embodiments, the door-facing surface 625 of the first jamb portion 615 may define a recess (e.g., cut out portion) that is configured for mounting the first strike plate 655A therein.

In various embodiments, the second strike plate 655B of a set of strike plates may be disposed between the first inner-facing surface 630 of the first jamb portion 615 and the second inner-facing surface 640 of the second jamb portion 620 such that the opening defined by the second strike plate 655B aligns with the opening defined by the first strike plate 655A, and thus aligns with the corresponding receiving component 510 (e.g., the corresponding locking projection opening 152 and cavity 154 of the jamb assembly 610). In this manner, a corresponding locking projection 120, when activated, may pass through the first and second strike plates 655A, 655B and the corresponding receiving component 150 (e.g., the corresponding locking projection opening 152 and cavity 154 of the jamb assembly 610), such that the corresponding locking projection 120 is disposed within the door jamb assembly 610.

As noted above, the door jamb assembly and the strike plates increase the structural strength of the receiving components 510, and accordingly significantly reduces the chances of forced entry. For example, if someone attempts to break down the door, the locking projections engage a side of the receiving components 510 (e.g., the locking projection openings 152 and cavities 154) of the doorway, thereby transferring forces to the strike plates and the door jamb portions 615, 620 that are secured to the strike plates 655A, 655B. The load is thus spread across strike plates and portions of the door jamb at each receiving portion (e.g., receiving components 510) location around the perimeter of the door, thereby significantly increasing the amount of force that can be withstood by the door jamb assembly, thus, the door.

Many modifications and other embodiments of the inventions set forth herein will come to mind to one skilled in the art to which these inventions pertain having the benefit of teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A locking mechanism for a door, the locking mechanism comprising:
a central locking component configured to engage one or more locking actuators;
a mortise lock linearly coupled to one of the one or more locking actuators of the central locking component, wherein the mortise lock comprises a mortise locking projection configured to be moved between a locked position and an unlocked position; and
at least one locking projection, wherein the at least one locking projection is configured to be moved between a locked position and an unlocked position via movement of a respective one of the at least one or more locking actuators,
wherein the mortise lock and the at least one locking projection are configured to synchronously move between the respective locked and unlocked positions in response to movement of the central locking component.

2. The locking mechanism of claim 1, wherein the mortise lock is configured to be removeable from the central locking component.

3. The locking mechanism of claim 1, wherein the mortise lock is linearly coupled with the same locking actuator as at least one of the at least one locking projection.

4. The locking mechanism of claim 1, wherein at least two locking projections are in communication with the same locking actuators.

5. The locking mechanism of claim 1, wherein at least one of the one or more locking actuators are configured to attach to a bell crank, such that the bell crank is operably coupled to at least one of the at least one locking projection.

6. The locking mechanism of claim 1 further comprising a lock activation component configured to move the mortise lock and the locking projections between the locked position and the unlocked position.

7. The locking mechanism of claim 1 further comprising a lock engagement mechanism, wherein the lock engagement mechanism is configured to activate the central locking component in response to actuation of the lock engagement mechanism.

8. The locking mechanism of claim 7, wherein the lock engagement mechanism comprises at least one of a sliding lock or handle.

9. A security door comprising:
a door frame configured for use within a doorway;
at least one door panel attached to the door frame; and
a locking mechanism comprising:
a central locking component configured to engage one or more locking actuators;
a mortise lock linearly coupled to one of the one or more locking actuators of the central locking component, wherein the mortise lock comprises a mortise locking projection configured to be moved between a locked position and an unlocked position; and
at least one locking projection, wherein the at least one locking projection is configured to be moved between a locked position and an unlocked position via movement of a respective one of the at least one or more locking actuators,
wherein the mortise lock and the at least one locking projection are configured to synchronously move between the respective locked and unlocked positions in response to movement of the central locking component, and
wherein the central locking component is attached to one of the at least one door panel and the mortise locking projection and the at least one locking projection are configured to protrude from the door frame in the locked position.

10. The security door of claim 9, wherein the door frame comprises a top door frame component, a bottom door frame component, a hinge side door frame component, and an opening side door frame component, wherein, in the locked position, at least one of the mortise locking projection or the at least one locking projection is configured to protrude from at least two of the top door frame component, the bottom door frame component, the hinge side door frame component, or the opening side door frame component.

11. The security door of claim 9, wherein the mortise locking projection and the at least one locking projection are configured to be perpendicular to the door frame.

12. The security door of claim 9, wherein the door frame comprises a first door panel configured to be attached to the door frame on a first side and a second door panel configured to be attached to the door frame on a second side, wherein the second side is disposed opposite the first side.

13. The security door of claim 9 wherein each of the locking projections is disposed within the security door in the locked position.

14. The security door of claim 9, wherein the door frame is configured to be received by a doorway comprising one or more receiving components, wherein at least one of the mortise locking projection or the at least one locking projection is configured to be received by a respective one of the one or more receiving components.

15. The security door of claim 9, wherein the mortise lock is configured to be removeable from the central locking component.

16. The security door of claim 9, wherein the mortise lock is linearly coupled with the same locking actuator as at least one of the at least one locking projection.

17. The security door of claim 9, wherein at least two locking projections are in communication with the same locking actuators.

18. The security door of claim 9 further comprising a lock activation component configured to move the mortise lock and the locking projections between the locked position and the unlocked position.

19. The security door of claim 9 further comprising a lock engagement mechanism, wherein the lock engagement mechanism is configured to activate the central locking component in response to actuation of the lock engagement mechanism.

20. The security door of claim 19, wherein the lock engagement mechanism comprises at least one of a sliding lock or handle.
